(19) United States
(12) Patent Application Publication
(10) Pub. No.: US 2005/0070751 A1
(43) Pub. Date: Mar. 31, 2005

(54) Method and apparatus for treating liquid waste

(76) Inventors: Jose A Capote, Kaohsiung (TW); Joseph A. Rosin, Northbrook, IL (US); Frank K. Menon, Round Lake, IL (US)

Correspondence Address: BRINKS HOFER GILSON & LIONE, P.O. BOX 10395, CHICAGO, IL, 60610, US

(21) Appl. No.: 10/673,078

(22) Filed: Sep. 27, 2003

(51) Int. Cl. A62D 3/00

(52) U.S. Cl. 588/311

(57) ABSTRACT

An apparatus for treating liquid waste includes a vessel, an AC plasma torch mounted with the vessel, and at least one nozzle mounted in the vessel. The nozzle is positioned so that liquid waste introduced through the nozzle into the vessel will be sprayed into or above a flame emitted by the AC plasma torch. Liquid waste is atomized by the nozzle and sprayed into the flame. The energy from the flame causes the organic portion of the atomized liquid waste to gasify and dissociate into elemental components. This dissociation destroys any hazardous or toxic constituency of the waste material.

### BACKGROUND

This invention relates to the treatment of waste material, and, more particularly, to the controlled thermal destruction of hazardous and non-hazardous liquid waste materials.

Solvents, such as organic solvents, are commonly used in many industrial applications. The solvent waste created in such applications is often hazardous and contains significant quantities of undesirable halogen compounds, such as organo-chlorides.

Due to the nature of solvent waste, it typically is not recycled for re-use and, instead, is disposed of in a sufficient manner. Incineration has been the principal means by which these materials are treated (landfilling is generally inadequate). In incineration, the hazardous components of the waste are attempted to be destroyed through combustion.

Incineration/combustion, however, has a number of deficiencies. For example, combustion requires large amounts of excess air. It can be difficult and costly to maintain combustion temperatures high enough (e.g., greater than 1,100° C.) to ensure complete destruction of the hazardous waste. Combustion is generally inefficient and can result in the incomplete destruction of the hazardous waste materials. Combustion of solvent waste, in particular, can lead to the formation of a number of undesirable compounds, such as dioxins and furans. In addition, combustion of solvent waste that contains significant levels of heavy metals can create potential hazardous emission problems.

### SUMMARY OF THE INVENTION

The present invention is defined by the following claims, and nothing in this section should be considered to be a limitation on those claims.

By way of introduction, one of the embodiments of the present invention described below includes a vessel, an AC plasma torch mounted with the vessel, and an air-atomizing spray nozzle that is mounted in the vessel. The nozzle is positioned so that liquid waste introduced through the nozzle into the vessel will be sprayed directly into or above a flame emitted by the AC plasma torch. The energy from the flame causes the organic portion of the liquid waste to gasify and dissociate into elemental components. This dissociation destroys any hazardous or toxic constituency of the waste material.

### BRIEF DESCRIPTION OF THE DRAWINGS

FIG. 1 is a partially schematic view of a waste treatment apparatus in accordance with the present invention.

FIGS. 2A and 2B are flow diagrams of a method for treating liquid waste in accordance with the present invention.

### DETAILED DESCRIPTION OF THE PREFERRED EMBODIMENTS

With reference to the figures, a waste processing system 100 will be described. The waste processing system 100 may be used to treat any type of hazardous and non-hazardous liquid product that may be decomposed upon the application of energy. For example, it may be used to treat liquid materials contaminated with polychlorinated biphenyls (PCBs), industrial and laboratory solvents, organic and inorganic chemicals, pesticides, organo-chlorides, and liquid refinery waste. In addition, the waste processing system 100 may be used to treat solid organic materials that are pulverized or that can be pulverized by a pretreatment system, such as a shredder. The waste product, furthermore, may include organic and inorganic components. Desirably, however, the waste processing system 100 is employed to treat liquid waste including mostly organic materials.

For ease of reference, the figures and description sometimes refer to the waste as solvent waste, which may include, for example, hazardous PCB-contaminated materials, organic chemical solvents, pesticides, organo-chlorides, and other liquid industrial and laboratory solvents. It is to be understood, however, that unless stated otherwise or unless it is clear from the context, when reference is made to solvent waste, it also encompasses other types of liquid waste.

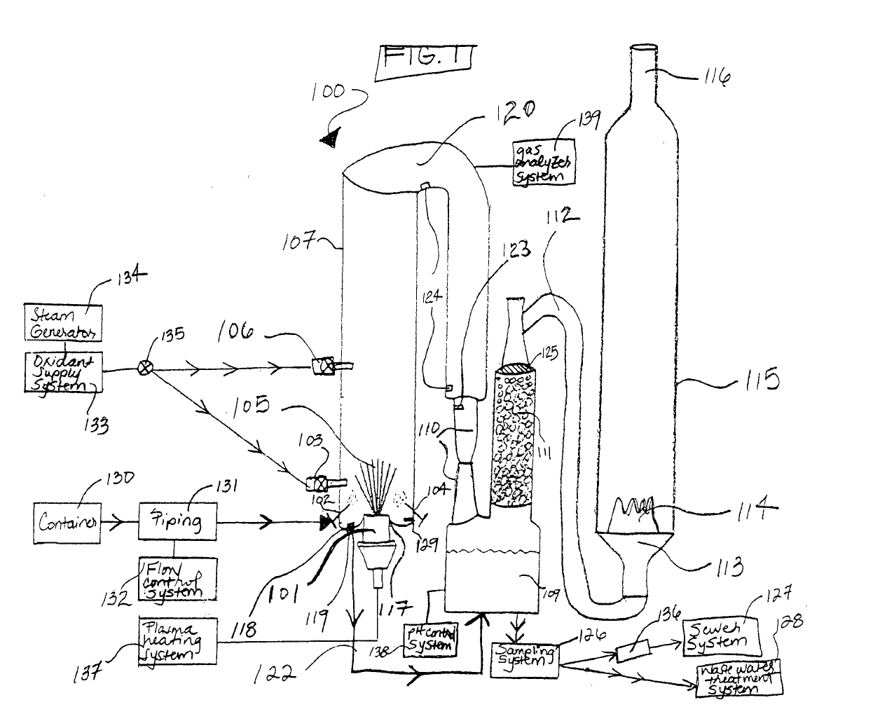

Referring to FIG. 1, a reformer vessel 107 is provided. The vessel 107 is vertically oriented and may be made of carbon steel. The vessel 107 may be oriented in other ways, such as horizontal, and may be made of other materials such as stainless steel or hastelloy. Furthermore, the vessel 107 may be lined with a combination of refractory materials that includes, for example, high-alumina. The vessel 107 and refractory materials can withstand elevated temperatures (in the range of 1,300 to 1,950° C. in a reducing atmosphere) that are maintained within the vessel 107 as described below.

An AC plasma arc torch 101 is mounted with the vessel through the torch receptacle opening 117 of the vessel 107. An exemplary AC plasma torch is manufactured by The Institute for Problems of Electrophysics—Russian Academy of Sciences (IPE-RAS), located in St. Petersburg, Russia. Desirably, the torch 101 is mounted so that the body of the torch 101 does not penetrate the vessel 107. By mounting the torch in this fashion, torch-cooling loads may be decreased thus increasing operating thermal efficiency and lowering cost and, in the event of a water line break inside the torch 101, the water will not flow into the vessel 107. In other embodiments, however, the body of the torch 101 partially or fully penetrates the vessel 107.

The AC plasma arc torch 101 emits a plasma flame 105 (a.k.a. plasma plume or plasma energy field) with temperatures exceeding about 6,000° C. The plasma flame 105 provides energy, which heats the interior of the vessel 107 to a uniform temperature preferably in the range of about 1,370° C. to about 1,950° C. A non-transferred or transferred type torch can be used for treating liquid waste that is high in organics. In comparison to transferred type torches, non-transferred type torches, particularly AC Torches, offer a larger plasma energy field that can provide greater bulk gas heating capability, increased arc stability, especially during the heat up period, simplified furnace design, and overall greater system reliability. A plasma heating system 137 further includes a power supply, a plasma gas compressor, and a cooling system. Alternatively, some or all of these components of the plasma heating system 137 may be housed with the torch 101. Furthermore, in the alternative, air may be introduced through the torch 101 and into the flame 101.

The waste processing system 100 can employ an AC plasma torch in contrast to a DC plasma torch. The AC torch has an inherently stable plasma plume that is more diffuse and dense compared to a DC torch. The wide plume enhances the ability of the torch to achieve molecular dissociation of the hazardous components in the waste being treated as further described below. In addition, an AC torch typically has a 30% to 60% lower operating cost than a DC torch. In the alternative, however, a DC torch may be used with the waste processing system described herein.

A feeding system introduces solvent waste into the vessel 107 through air-atomizing spray nozzles 102 and 104, which are mounted within the vessel 107. While only two nozzles are shown in the embodiment illustrated in FIG. 1, it is to be understood that any number of nozzles may be used for introducing solvent waste into the vessel 107. For example, only one nozzle may be used or ten nozzles, equally or non-equally spaced apart, may be used. Desirably, however, enough nozzles are used to accommodate the desired rate at which the solvent is collectively fed into the vessel.

Waste may be fed through the nozzles simultaneously, from the same or separate waste sources, or the waste may be fed through the nozzles in an alternating or sequential manner. In addition, the liquid waste fed through each nozzle may be different. For example, the solvent waste from one manufacturing process may be introduced through one nozzle and solvent waste with a different constituency from a different manufacturing process may be introduced through another nozzle (simultaneously or in an alternating manner). The number of nozzles used and the manner in which they are employed will depend on the particular application.

The nozzles 102 and 104 are positioned to introduce the atomized solvent waste into the plasma energy field 105. In other implementations, the solvent waste is introduced into other areas in relation to the plasma energy field 105, such as into the area above the plasma energy field 105. Desirably, the waste is introduced directly into the zone of highest energy in the plume 105 and above that zone in order to enhance molecular dissociation. In addition, the nozzles can be positioned in open areas of the vessel 107 that are surrounded by refractory materials. This positioning can facilitate the transfer of energy from the flame 105 to the solvent waste.

The nozzles 102 and 104 can be configured to maximize the surface area of the solvent waste micro-droplets that are generated. By maximizing the surface area of the droplets, energy from the plasma flame 105 may be transferred to the droplets at a greater rate. This can be accomplished by mixing compressed air with the solvent waste in the nozzles. An exemplary nozzle is the Flomax FM1 nozzle manufactured by Spraying Systems Co., located in Wheaton, Ill. In addition, an exemplary rate for introducing the compressed air into the nozzle is about 780 kg/hour.

The feeding system includes a container 130 that houses the solvent waste and piping 131 connecting the container and the nozzles 102 and 104. The piping 131 may be constructed of stainless steel, seamless pipe (for example, SS 304 and/or SS 316). In addition, the feeding system can include a flow control system 132, such as a PLC-based flow control system with a pump, connected with the piping that is capable of automatic and remote manual set points to high levels of precision. An exemplary pump is the Multi-Stage Centrifugal pump made by Goulds Pumps (back pressure control valves may also be used). It should be understood, however, that the particular feeding system employed is generally application specific. It should also be understood that any type of known means, or any means subsequently developed, for feeding or transferring the solvent waste to the nozzles 102 and 104 may be employed with the waste processing apparatus described herein. For example, solvent waste may be transferred to the nozzles 102 and 104 through a single pipe or through multiple pipes that feed into a single pipe. Conversely, the solvent waste may be transferred through a single pipe that feeds into multiple pipes where each of the multiple pipes feeds a separate nozzle.

The rate at which the solvent waste is fed into the vessel 107 through the nozzles 102 and 104 may be initially calculated based on an estimation of the energy required to process the specific waste type being treated. The desired feed rate is determined by actual operation of the system, and is selected to maintain a desired average temperature within the vessel 107. The torch 101 inputs energy into the vessel 107 and the waste absorbs the energy as it is fed into the vessel 107. An excessive feed rate maintained for a period of time can cause the interior temperature of the vessel 107 to decrease. Conversely, an inadequate feed rate can cause the vessel 107 to overheat. Accordingly, the desired feed rate is selected to achieve the desired average temperature, which may be in the range of about 1,370° C. to 1,950° C. In any event, an exemplary waste processing system is capable of processing approximately 1,000 pounds of solvent waste per hour, using a 125 to 450 kW AC plasma torch. In addition, an exemplary feed rate is about 450 to 700 kg/hour or a solvent waste flow rate of about 0.5 to about 2.5 GPM at a pressure of about 58 to about 78 psi. Desirably, the solvent waste flow rate is about 1 GPM at a pressure of about 64 psig. The desired feed rate, however, can change depending on the make-up of the solvent waste and its viscosity.

In operation, atomized solvent waste is introduced directly into or above the plasma energy plume 105 through the nozzles 102 and 104. As the waste material is introduced into the vessel 107, it absorbs energy by convection, conduction, and radiation from the plasma flame 105, the heated refractory lining, and the heated gases circulating in the vessel 107. Generally speaking, this energy does not affect the inorganic and organic portions of the waste in the same manner.

The inorganic portion of the waste, if it is present, can include a minor amount of particulates and solids suspended in the liquid solvent waste. As the solvent waste is introduced into the vessel 107, these particulates will generally be carried out of the plasma plume 105 and will precipitate in a water bath positioned in a valley 118 at the bottom of the vessel 107. The valley 118 can be circular shaped or may be other shapes to hold the water. In addition, a vertical flow of gases (away from the torch 101) is created as a result of a negative pressure generated in the vessel 107 by a downstream ejector-venturi scrubber 110. Therefore, the lighter particulates may be entrained in the gases and carried upstream out of the vessel 107. These particulates are removed from the gases by a treatment system further described below.

Small amounts of refractory material lining the inside of the vessel 107 (i.e. further inorganic material) may accidentally fall away from the walls of the vessel 107. These materials will also collect in the water bath at the bottom of the vessel 107 along with the inorganic particulate from the waste stream.

The bath may be drained from the vessel 107 through a drain 1119. As the bath is drained, a minor amount of inorganic material may remain behind as sediment. Accordingly, a jet 129 (or alternatively, multiple jets) may be provided at the lower portion of the vessel 107 to spray down the valley 118 with water during or after draining of the bath. The spray can help maximize the removal of the inorganic materials from the vessel 107. In addition, the spray may be used to fill the water bath when the drain 119 is closed.

The inorganic particulates drained from the vessel may then be pumped or flowed by gravity (represented schematically by the line and arrows designated 122) to a collecting tank 109, which desirably holds up to 3,000 liters, but can hold other amounts. In the tank 109, the particulate will be mixed with the blowdown from the ejector-venturi scrubber 110 and absorber 111, as further described below. The combined discharge (blowdown plus particulate) may be sampled by a sampling system 126, and if found to meet regulatory discharge standards, discharged to a sewer system 127 or, if further treatment is required, discharged to a wastewater treatment system 128. To aid in maintaining the solution in the tank 109 within pollution control requirements, a pH control system 138 may be provided to maintain the water at a pH of between about 7 and 12.

The discharge to the sewer system may be made via gravity or pump action through piping, such as a 4-inch or 2-inch seamless, stainless steel pipe. Before the discharge reaches the sewer system, the discharge may be flowed through a heat exchanger 136 that cools the discharge solution (for example, from about 80° C. to a maximum of about 40° C.).

Turning now to the organic portion of the waste material, as the solvent waste comes into contact with the plasma flame 105, it is gasified and dissociated. Generally speaking, gasification occurs because the energy contained in the plasma flame 105 is higher than the energy (bonding energy) holding the organic molecules together. This gasification and dissociation process is generally called molecular dissociation pyrolysis (pyrolysis is a process by which intense heat operating in an extremely low oxygen environment dissociates molecules, as contrasted with incineration or “burning”).

Accordingly, the organic molecules dissociate into their elemental components, mainly solid carbon (fine carbon particulate) and hydrogen gas. Oxygen, nitrogen, and the halogens (typically chlorine) are also liberated if present in the waste in a hydrocarbon derivative. The time required to achieve dissociation varies slightly for different materials, but is typically under a second and often milliseconds for most compounds at or above 1100° C. Thus, hazardous waste, which is generally made up of complex organic compounds including hydrogen, oxygen, nitrogen and carbon atoms, is disassociated into its elemental atomic constituents. This dissociation destroys the hazardous or toxic constituency of the solvent waste material.

Upon dissociation, oxygen and chlorine are free to react with the abundant carbon and hydrogen produced and could theoretically reform a wide array of complex (and potentially hazardous) organic compounds. Such compounds, however, generally cannot form at the high temperatures maintained within the vessel 107 at which only a limited number of simple compounds are stable. The most common and stable of these simple compounds are carbon monoxide (formed from a reaction between the free oxygen and carbon particulate), diatomic Nitrogen, and hydrogen chloride gas (when chlorine is present).

There is normally an insufficient amount of oxygen liberated from the waste material to convert all of the fine particulate carbon to carbon monoxide gas. While water in the waste may liberate additional oxygen, the conversion of the solid carbon to carbon monoxide gas will typically not be maximized. As a result, fine carbon particulate may be undesirably entrained and carried upstream and out of the plasma plume 105 by the hydrogen dominated gas stream.

To maximize the conversion of solid carbon to carbon monoxide gas, an additional source of oxygen may be used. Accordingly, the waste processing system 100 includes a means for injecting an oxidant into the vessel 107 in an amount effective to convert a major portion of the carbon particulate to carbon monoxide or carbon dioxide. The injection means is desirably an oxidant supply system 133, such as the oxidant supply system and related components disclosed in U.S. Pat. No. 5,534,659, which is hereby incorporated by reference, that includes a steam generator 134 and a steam valve 135 that may be opened in a controlled manner to supply steam to injectors 103 and 106. The injectors 103 and 106, in turn, inject predetermined amounts of steam into the vessel 107. In addition, oxygen may be introduced into the vessel through other means, including air and pure oxygen gas.

The steam injected into the system converts the free carbon into primarily carbon monoxide. Because pure carbon is more reactive at the high operating temperatures than the carbon monoxide gas, additional oxygen injected into the vessel should react with the carbon and form carbon monoxide, and not with the carbon monoxide to form carbon dioxide (assuming that the oxygen is not added in excess). Carbon dioxide is also relatively less stable at the high pyrolysis temperatures than carbon monoxide.

The amount of oxygen added through the injectors 103 and 106 is closely controlled if the end-product gas will be productively used. Excess oxygen in the system may cause combustion to occur, which can potentially lead to the formation of carbon dioxide (which has no fuel value) or other undesirable compounds such as polyaromatic hydrocarbons, dioxins, and furans. The proper amount of oxidant injected through the injectors 1103 and 106 may be determined through several alternative means, including pre-established set points that may be precisely controlled by a logic control system or through feedback control loops utilizing data provided by a gas analyzer system 139 that continuously monitors and analyzes the synthesis gas. Further examples and details concerning means to determine, monitor, and/or control the amount of oxygen added to the system are disclosed in U.S. Pat. No. 5,534,659.

The resulting gas (after partial oxidation and/or controlled pyrolysis) includes carbon monoxide, hydrogen, carbon dioxide, water vapor, methane, and nitrogen. This gas, called a synthesis gas, travels up through the vessel 107, and through a carbon steel pipe, called a “hot pipe” or ductwork 120, and then to the ejector-venturi scrubber 110.

The ductwork 120 is arranged to convey the synthesis gas at a temperature of between about 1250° C. and 1350° C. to the ejector/venturi scrubber 110. For example, the ductwork 120 may be refractory lined and thermally insulated. In addition, the ductwork 120 is designed to be airtight to prevent the introduction of unwanted air into the synthesis gas stream.

The gas is then rapidly cooled in the ejector-venturi scrubber 110 to a temperature in the range of about 40° C. to 80° C. The ejector-venturi scrubber 110 may be constructed of carbon steel or a specialty metal, such as Hastelloy, and may be lined with refractory materials.

A spray nozzle 123 is mounted at or near the top of the ejector-venturi scrubber 10 and sprays a scrubbing solution (such as water or a sodium hydroxide solution) down through the ejector-venturi scrubber 110, which collects in the tank 109 (and may be recirculated, for example, with a pump). The scrubbing solution is desirably introduced into the ejector-venturi scrubber 110 at a rate of about 750 to 1,300 liters/minute. At this rate, a pressure (draft) is created through the system, which induces the flow of gases away from the torch 101 and through the ejector-venturi scrubber 110. In addition, the feed rate creates a backpressure against the spray nozzle, which helps atomize the scrubbing solution into fine droplets. Fine droplets are desirable, because they provide increased surface area.

The atomized scrubbing solution helps remove inorganic particulates, heavy metals, and carbon particulates entrained in the synthesis gas. These materials are carried by the scrubbing solution into the tank 109 (while the gas continues on through the waste treatment system 100).

When used in conjunction with the molecular dissociation pyrolysis process, the ejector-venturi scrubber 110 provides a number of advantages over alternatives (including dry and semi-dry scrubbers). These advantages include high resistance to gas ignition, prevention of the formation of dioxins and furans, and maximization of the removal of unreacted carbon particulates. The alternative scrubbers, however, may still be used in other embodiments.

The ejector-venturi scrubber 110 can be located close to the vessel 107 to minimize heat loss and cooling until the gas reaches the ejector-venturi scrubber 110 and is rapidly cooled. High temperature thermocouples 124 can monitor the gas temperature exiting the vessel 107 and downstream proximate to the inlet of the ejector-venturi scrubber 110.

It is desirable to maintain the temperature of the gas above about 1,000° C. before it is rapidly cooled in the ejector-venturi scrubber 110 to minimize or prevent the formation of hazardous or toxic substances such as furans or dioxins. Various operating parameters may be used to maintain the synthesis gas temperature within the preferred operating range. The operating gas temperature inside the vessel 107, for example, is at least partially a function of balancing the AC torch power input and the waste material feed rate. The AC torch 101 provides the principal requisite amount of heat to ensure the molecular dissociation and to maintain a minimum bulk vessel temperature, which may be determinative of the gas temperature. The waste absorbs heat energy as it is fed into the chamber. Because the torch power is primarily fixed by its size and operating parameters, the waste feed rate may be used to prevent the vessel 107 from overheating or under heating, and thereby to regulate the chamber/gas temperature.

Another parameter that can influence gas temperature is the amount of combustion/oxidation that occurs to form carbon dioxide. For example, injecting additional excess steam into the vessel 107 may allow a larger percentage of carbon to oxidize to carbon dioxide. This reaction is exothermic, and it releases additional heat, which tends to raise temperature. This reaction may be promoted to raise temperatures at the beginning of the waste treatment process; however, it lowers the fuel quality of the end-product gas and, accordingly, it is a less desirable aspect of the process if the end-product gas is intended for productive use.

After the synthesis gas is cooled and scrubbed by the ejector-venturi scrubber 110, it is flowed upward through an absorber 111, such as a conventional packed tower absorber. The packed bed may consist of random or high performance packing that provides a close gas-liquid contact. The absorber 111 removes and neutralizes gaseous pollutants in the synthesis gas such as acid gases (e.g., hydrogen chloride gas).

While the synthesis gas is flowing upward through the absorber 111, a liquid scrubbing solution (such as the scrubbing solution described above) flows downward through the absorber 111 by gravity over the packing. The scrubbing solution helps remove any remaining inorganic particulates, heavy metals, or carbon particulates similar to the scrubbing solution discussed above with respect to the ejector-venturi scrubber 110. The solution collects in the tank 109 along with the blowdown from the ejector-venturi scrubber 110 (and the drainage from the vessel 107) and may be recirculated or disposed of as further described above.

A means for removing any moisture, such as liquid droplets of scrubbing solution, which may be entrained in the synthesis gas may be provided at the top of the absorber 111 or further upstream. The means may be radial vane mist eliminators, chevron mist eliminators, and/or cyclonic mist eliminators. The embodiment illustrated in FIG. 1 includes a radial mist eliminator 125.

The synthesis gas exiting the absorber 111 may then be transported to a conventional energy recovery system (i.e. a system that utilizes the energy of the synthesis gas). Such recovery systems are well known. The resulting clean fuel gas is mostly hydrogen and carbon monoxide and, more particularly, is roughly about 20-30% hydrogen gas and about 15-30% carbon monoxide gas. The gas can be used as a fuel for steam or electricity generating equipment or the hydrogen can be extracted as a clean fuel or precursor in many important manufacturing processes (e.g., plastics and methanol production). In addition, as an alternative to natural gas for electricity production, the resulting clean fuel gas produced as described herein has the ability to help preserve valuable fossil fuels.

Alternatively, if the resulting clean fuel gas will not be used productively, a thermal oxidizer system may be provided, as illustrated in FIG. 1, to combust the gas. The thermal oxidizer system includes a thermal stack 115 with exhaust pipe 116 and a conventional low NOₓ burner 13 mounted at the bottom of the thermal stack 15.

The burner 113 should be configured to combine the synthesis gas feed, combustion air (to help control the temperature and foster the oxidation of the gases), and a supplementary fuel source (natural gas or propane may be used). In operation, the thermal stack 115 should be pre-heated to a minimum temperature of about 815° C. (in general, this requires the combustion of about 2 to 4 million BTU/hour of natural gas). Once the desired temperature is achieved, the synthesis gas from the absorber 111 may be introduced into the thermal stack 115 through the piping 112. The synthesis gas should combust within the thermal stack 115 as long as it remains within the thermal stack 115 for at least about 0.5 seconds.

The combustion of the synthesis gas releases energy, which sustains further combustion. Accordingly, the combustion of supplementary fuel in the burner 113 is generally not needed after the thermal stack 115 has been pre-heated. In some circumstances, however, additional energy may be necessary to maximize combustion of the synthesis gas, especially where the gas contains a significant percentage of water vapor. In such cases, the burner may be activated to provide additional energy and raise the temperature in the thermal stack 115 above about 1500° F., which should combust the gas regardless of its heating value. The temperature within the thermal stack 115, however, should not exceed 1600° F. in order to minimize the generation of NOₓ gas. In any event, the heat energy of the products of the combustion of the synthesis gas, which include primarily carbon dioxide and water vapor, can be used to produce steam and electricity in a steam turbine.

The thermal oxidizer system contemplates the use of the burner 113, which raises the cost of waste treatment due to the cost of the fuel source, e.g. natural gas. As an alternative, this cost may be avoided if, during oxidation of the synthesis gas in the vessel 107, excess oxygen is added. The excess oxygen leads to the formation of an end-product gas consisting mostly of carbon dioxide, water vapor, and nitrogen (not carbon monoxide and hydrogen gas). While this gas has little fuel value (and is not intended for productive use), the gas is benign and, therefore, it is unnecessary to combust the synthesis gas in the thermal oxidizer system. Accordingly, the gas may be directly exhausted into the environment after being treated in the absorber 111 and operational costs may be decreased.

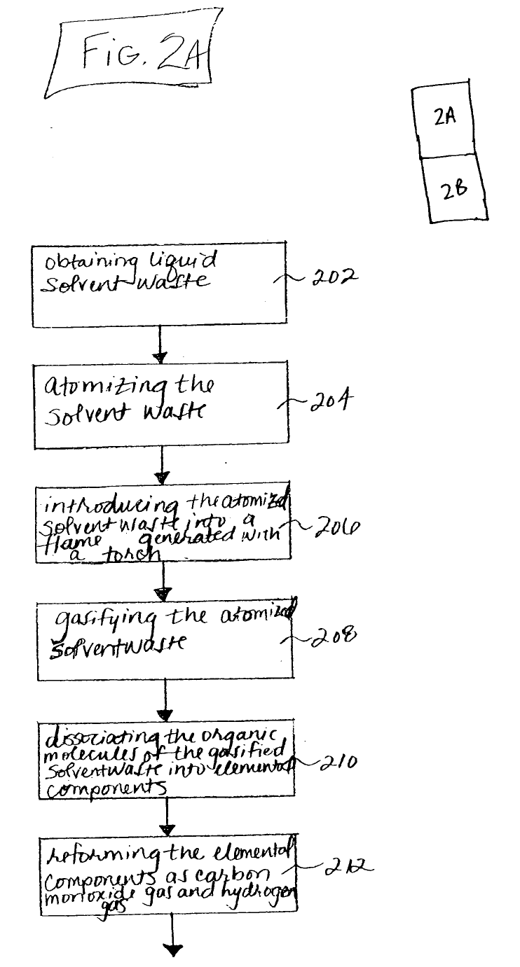

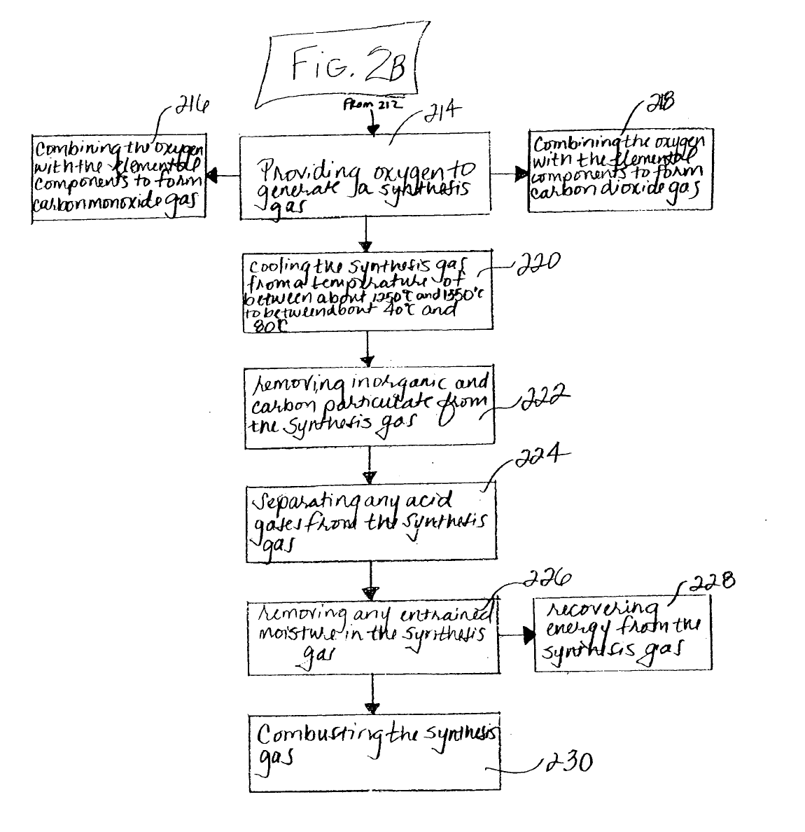

FIGS. 2A and 2B represent flow diagrams of an exemplary method for treating waste, such as with the above described waste treatment apparatus. It should be understood, however, that the method steps illustrated by the blocks in FIGS. 2A and 2B may be performed in other sequences, other steps may be added, and/or one or some of the steps may be skipped or deleted.

At block 202, liquid solvent waste is obtained. At block 204, the solvent waste is atomized. At block 206, the atomized solvent waste is introduced into a flame generated with a plasma torch, such as an AC plasma torch. At block 208, the atomized solvent waste is gasified. At block 210, the gasified solvent waste dissociates into elemental components, such as hydrogen, carbon, oxygen, and nitrogen. At block 212, the elemental components reform as carbon monoxide gas and hydrogen gas.

At block 214, oxygen is added to the elemental components to generate a synthesis gas. At block 216, the oxygen is combined with the elemental components to form additional carbon monoxide gas. Alternatively, at block 218, the oxygen is combined with the elemental components to form carbon dioxide gas.

At block 220, the synthesis gas is cooled from a temperature of between about 1250° C. and 1350° C. to between about 40° C. and 80° C. At block 222, inorganic and carbon particulate entrained in the synthesis gas are removed from the synthesis gas. At block 224, acid gases are removed from the synthesis gas.

At block 226, entrained moisture, such as moisture from a scrubbing solution, is removed from the synthesis gas.

At block 228, the energy contained in the synthesis gas is recovered.

Alternatively, at block 230, the synthesis gas is combusted.

The methods and apparatus described herein can differ from known methods and apparatus involving combustion (incineration). The waste processing system described herein can utilize energy from a torch, such as an AC plasma torch, to thermally decompose waste through pyrolysis (an oxygen-starved process). Incinerators, on the other hand, use combustion to create energy (heat) to propagate the continued destruction of the waste material (an oxygen-required process). In addition, the waste processing system described herein generally does not generate hazardous bottom ash, fly ash, dioxin, or furan, all of which are commonly found in or created by incinerators.

Furthermore, the methods and apparatus described herein can differ from methods and apparatus that use DC plasma torches. For example, DC torches have been used to treat PCB-contaminated liquid waste, but the PCB waste must be diluted and mixed with a significant amount of steam, an oxidizing agent, before the waste is introduced into the flame generated by the DC torch. In the waste processing system described herein, on the other hand, PCB waste may be introduced into the flame generated by the torch, such as an AC torch, without first diluting or mixing it with steam or other material. In addition, unlike the waste processing system described herein, known methods and apparatus using DC torches are limited in capacity (the PCB waste can only be introduced into the flame in low quantities) and cannot be employed on a commercial scale. Likewise, such systems do not produce a synthesis gas that may be productively used, do not allow for large throughputs, and do not provide for other materials, such as solvents, to be mixed with the PCB waste and simultaneously treated. Moreover, such systems oxidize (i.e. “burn”) the waste in the plasma flame whereas the waste processing system described herein “cracks” and gasifies the waste in a pyrolysis process.

The foregoing description of the invention has been presented to illustrate the principles of the invention and not to limit the invention to any particular embodiment illustrated. It is therefore intended that the foregoing detailed description be regarded as illustrative rather than limiting, and that it be understood that it is the following claims, including all equivalents, that are intended to define the spirit and scope of this invention.

1. An apparatus for treating liquid waste comprising:
(a) a vessel;
(b) an AC plasma torch mounted with the vessel; and
(c) at least one nozzle mounted in the vessel, wherein the nozzle is positioned in the vessel to introduce liquid waste into or above a flame emitted by the AC plasma torch.

2. The apparatus for treating liquid waste of claim 1 wherein the nozzle is an air-atomizing spray nozzle.

3. The apparatus for treating liquid waste of claim 2 wherein the flame has a temperature exceeding about 6000° C.

4. The apparatus for treating liquid waste of claim 3 wherein the flame heats the vessel to a temperature of about 1370° C. to about 1950° C.

5. The apparatus for treating liquid waste of claim 4 wherein AC plasma torch has a body, and the body of the AC plasma torch does not penetrate the vessel.

6. The apparatus for treating liquid waste of claim 5 wherein the nozzle is positioned to introduce the liquid waste into the zone of highest energy in the flame.

7. The apparatus for treating liquid waste of claim 1 further comprising:
(a) a feeding system connected to the nozzle;
(b) at least one injector mounted in the vessel;
(c) an oxidant supply system connected to the injector; and
(d) a drain disposed within the vessel.

8. The apparatus for treating liquid waste of claim 7 further comprising:
(a) an ejector-venturi scrubber connected with the vessel;
(b) a collecting tank connected with the ejector-venturi scrubber; and
(c) a absorber connected with the collecting tank.

9. The apparatus for treating liquid waste of claim 8 further comprising:
(a) a thermal oxidizer system connected with the absorber comprising a thermal stack, an exhaust pipe, and a burner.

10. The apparatus for treating liquid waste of claim 8 further comprising:
(a) an energy recovery system connected with the absorber.

11. The apparatus for treating liquid waste of claim 7 wherein the feeding system comprises a container, piping interconnecting the container and the nozzle, and a flow control system connected with the piping.

12. A method for treating liquid waste comprising:
(a) providing an AC plasma torch;
(b) providing liquid waste;
(c) atomizing the liquid waste;
(d) generating a plasma flame with the AC plasma torch; and
(e) introducing the atomized liquid waste into or above the flame.

13. The method for treating liquid waste of claim 12 wherein the liquid waste comprises hazardous solvent waste.

14. The method for treating liquid waste of claim 13 further comprising:
(a) dissociating the organic molecules of the gasified liquid waste into elemental components;
(b) gasifying the atomized liquid waste; and
(c) reforming the elemental components as carbon monoxide gas and hydrogen gas.

15. The method for treating liquid waste of claim 14 wherein the step of dissociating the organic molecules destroys the hazardous constituency of the organic portion of the liquid waste and is accomplished through pyrolysis of the liquid waste.

16. The method for treating liquid waste of claim 15 further comprising:
(a) providing oxygen; and
(b) combining the oxygen with the elemental components to form carbon dioxide gas.

17. The method for treating liquid waste of claim 15 further comprising:
(a) cooling the carbon monoxide gas and hydrogen gas from a temperature of between about 1250° C. and 1350° C. to between about 40° C. and 80° C.;
(b) removing carbon particulate from the carbon monoxide gas and hydrogen gas; and
(c) separating any acid gases from the carbon monoxide gas and hydrogen gas.

18. A method for treating hazardous solvent waste comprising:
(a) providing a first source of hazardous liquid solvent waste;
(b) providing a first nozzle;
(c) providing an AC plasma torch;
(d) generating a flame from the torch; and
(e) injecting the solvent waste from the first source through the first nozzle directly into the flame.

19. The method for treating hazardous solvent waste of claim 18 further comprising:
(a) providing a second source of hazardous liquid solvent waste;
(b) providing a second nozzle; and
(c) injecting the solvent waste from the second source through the second nozzle directly into the flame.

20. The method for treating hazardous solvent waste of claim 19 wherein the solvent waste from the first source and the solvent waste from the second source are injected through the respective nozzles in an alternating manner.
